(19) United States
(12) Patent Application Publication
(10) Pub. No.: US 2026/0140377 A1
(43) Pub. Date: May 21, 2026

(54) OPTICAL MODULES AND HEAD MOUNTED DISPLAY DEVICE

(71) Applicant: GOERTEK OPTICAL TECHNOLOGY CO., LTD., Weifang, Shandong (CN)

(72) Inventor: CHAIYUAN SHI, Shandong (CN)

(73) Assignee: Goertek Optical Technology Co., Ltd., Weifang, Shandong (CN)

(21) Appl. No.: 18/867,246

(22) PCT Filed: Jun. 27, 2022
(86) PCT No.: PCT/CN2022/101448

§ 371 Date: Jul. 18, 2025

(30) Foreign Application Priority Data
May 19, 2022 (CN) 202210557910.4

(51) Int. Cl. G02B 27/01

(52) U.S. Cl. CPC G02B 27/0172

(57) ABSTRACT

Embodiments of the present disclosure provide an optical module and a head mounted display device. The optical module includes a display, a beam splitter, a phase retarder and a polarization reflecting element, wherein the phase retarder is provided between the beam splitter and the polarization reflecting element. The optical module further includes a first lens and a second lens arranged sequentially, the first lens is provided between the display and the beam splitter and the second lens is provided on one side of the beam splitter away from the display. A ratio of a difference between the optical effective aperture D₂ of the beam splitter and the height D₁ of the effective display area of the display to a distance T between the beam splitter to the display is 2 to 6. In the embodiment of the present disclosure, by providing an optical lens between the beam splitter and the display, the angle at which light is incident to the beam splitter and the angle at which light from the display is incident to the optical lens can be effectively constrained, thereby improving the light efficiency.

### FIELD OF THE INVENTION

Embodiments of the present disclosure relate to the technical field of near-eye display imaging, and particularly to an optical module and a head mounted display device.

### BACKGROUND OF THE INVENTION

In recent years, Augmented Reality (AR) technology and Virtual Reality (VR) technologies have been applied and rapidly developed in, for example, smart wearable devices. Core components of both AR and VR technologies are optical modules. The quality of the smart wearable devices directly depends on display effects of the optical modules.

In the prior art, to achieve a miniaturized and lightweight virtual reality imaging system, it requires a smaller screen. However, under the same optical specifications (e.g., field of view angle, imaging quality, etc.), the smaller the size of the screen, the more stringent the requirements become for the optical module. For existing folded optical paths, under the demand for a large field of view, as the screen size decreases, the optical power required by the optical module increases, thereby raising the requirements for both the angle of incidence of light onto the transflective film and the emission angle of the screen itself. As the angle of incidence increases, the reflectance and transmittance of the transflective film decrease. Meanwhile, since the emission angle of the screen is constant, when the angle of incidence of the light emitted from the screen to the optical module is too large, some angles will not be covered by the screen's emission angle, leading to a reduction in light efficiency and impacting the final image quality of the optical module.

### SUMMARY OF THE INVENTION

The purpose of the present disclosure is to provide a new technical solution for an optical module and a head mounted display device.

In a first aspect, the present disclosure provides an optical module including a display, a beam splitter, a first phase retarder and a polarizing reflection element, wherein the first phase retarder is provided between the beam splitter and the polarizing reflection element.

The optical module further includes a first lens and a second lens arranged sequentially. The first lens is provided between the display and the beam splitter, and the second lens is provided on a side of the beam splitter away from the display.

A ratio of the difference between the optical effective aperture D₂ of the beam splitter and the height D₁ of the effective display area of the display to the distance T between the beam splitter and the display is in a range from 2 to 6.

Optionally, the ratio of the difference between the optical effective aperture D₂ of the beam splitter and the height D₁ of the effective display area of the display to the distance T between the beam splitter and the display is in a range from 2.9 to 4.2.

Optionally, the display has a size of 1.0 inches to 2.1 inches.

Optionally, an angle of light incident onto the beam splitting element is smaller than 65°.

Optionally, the optical module further includes a third lens, and the second lens is provided between the first lens and the third lens;

Either side of the third lens is provided with the first phase retarder and the polarizing reflection element.

Optionally, the center thickness T₁ of the first lens is 2 mm<T₁<5 mm.

The first lens includes a first surface and a second surface, both of which are aspherical.

Optionally, the first lens has an optical power φ₁, which is positive and satisfies: 0≤φ₁<0.05.

Optionally, the aperture D of the third lens satisfies: D₁≤D≤D₂.

Optionally, the second lens includes a third surface and a fourth surface, the third surface is aspherical and the fourth surface is planar or aspherical.

The third lens includes a fifth surface and a sixth surface, both of which are aspherical.

Here the fourth surface is provided adjacent to the fifth surface.

Optionally, the beam splitter is provided on one side of the third surface.

The first phase retarder and the polarizing reflection element are arranged sequentially between the fourth surface and the sixth surface.

Optionally, the optical module further includes a polarizing film provided between the polarizing reflection element and the sixth surface.

Optionally, the beam splitter is attached to the third surface.

The first phase retarder is attached to the fourth surface.

The polarizing reflection element and the polarizing film are stacked to form a film layer structure and attached to the sixth surface.

Optionally, the first lens, the second lens and the third lens have a refractive index n of: 1.4<n<1.7.

The dispersion coefficient v of the first lens, the second lens and the third lens is: 20<v<75.

Optionally, the beam splitter has a reflectivity of 47% to 53%.

Optionally, the light emergent surface of the display is configured to be capable of emitting circularly polarized light or linearly polarized light.

When light emitted from the light emergent surface of the display is linearly polarized light, a second phase retarder is provided between the light emergent surface of the display and the first lens, and the second phase retarder is configured to convert the linearly polarized light into circularly polarized light.

In a second aspect, the present disclosure provides a head mounted display device, including:
a housing; and
the optical modules as described above.

According to an embodiment of the present disclosure, a technical solution for a folded optical path is provided. By providing a first lens between the beam splitter and the display in the light path structure, the angle at which light is incident to the beam splitter and the angle at which the light emitted from the display is incident to the first lens are improved. This ensures that the angle at which the light emitted from the display is incident to the first lens falls within the range of the original incident angle of the display, thereby improving light efficiency and contributing to enhanced imaging quality.

Other features of the specification and advantages thereof will become clear by the following detailed description of exemplary embodiments of the present specification with reference to the accompanying drawings.

### BRIEF DESCRIPTION OF THE DRAWINGS

The accompanying drawings incorporated in and constituting a part of the specification illustrate embodiments of present disclosure and together with the description thereof, serve to explain the principles of the disclosure.

FIG. 1 shows one of the structural schematic diagrams of an optical module provided by an embodiment of the present disclosure;

FIG. 2 shows a schematic diagram of a local structure of an optical module provided by an embodiment of the present disclosure;

FIG. 3 shows a schematic diagram of the spot array of the optical module illustrated in FIG. 1;

FIG. 4 shows a graph of MTF curves of the optical module illustrated in FIG. 1;

FIG. 5 shows field curvature distortion of the optical module illustrated in FIG. 1;

FIG. 6 shows a graph of lateral chromatic aberration of the optical module illustrated in FIG. 1;

FIG. 7 shows a schematic diagram of the variation of the emission angle of the display and the beam splitter in the optical module illustrated in FIG. 1;

FIG. 8 shows a second structural schematic diagram of an optical module provided by an embodiment of the present disclosure;

FIG. 9 shows a third structural schematic diagram of an optical module provided by an embodiment of the present disclosure;

FIG. 10 shows a schematic diagram of the spot array of the optical module illustrated in FIG. 9;

FIG. 11 shows a graph of MTF curves of the optical module illustrated in FIG. 9;

FIG. 12 shows field curvature distortion of the optical module illustrated in FIG. 9;

FIG. 13 shows a graph of lateral chromatic aberration of the optical module illustrated in FIG. 9;

FIG. 14 shows a schematic diagram of the variation of the emission angle of the display and the beam splitter in the optical module illustrated in FIG. 9;

FIG. 15 is a fourth structural schematic diagram of an optical module provided by an embodiment of the present disclosure;

FIG. 16 shows a schematic diagram of the spot array of the optical module illustrated in FIG. 15;

FIG. 17 shows a graph of MTF curves of the optical module illustrated in FIG. 15;

FIG. 18 shows field curvature distortion of the optical module illustrated in FIG. 15;

FIG. 19 shows a graph of lateral chromatic aberration of the optical module illustrated in FIG. 15;

FIG. 20 shows a schematic diagram of the variation of the emission angle of the display and the beam splitter in the optical module illustrated in FIG. 15; and

FIG. 21 shows a schematic diagram of the emission angle of a display and a beam splitter in an optical module of an embodiment of the present disclosure.

### EXPLANATION OF REFERENCE NUMERALS

10, first lens; 11, first surface; 12, second surface; 20, second lens; 21, third surface; 22, fourth surface; 30, third lens; 31, fifth surface; 32, sixth surface; 40, beam splitter; 50, phase delayer; 60, polarizing reflection element; 70, polarizing film; 80, display; 81, protective glass; 90, anti-reflection film; 01, Human eye.

### DETAILED DESCRIPTION OF THE EMBODIMENTS

Various exemplary embodiments of the present disclosure will now be described in detail with reference to the accompanying drawings. It should be noted that the relative arrangements of the components and steps, numerical expressions and values set forth in these embodiments do not limit the scope of the present disclosure unless otherwise specifically stated.

The following description of at least one exemplary embodiment is in fact merely illustrative and in no way serves as any limitation on the present disclosure and its application or use.

Techniques and devices known to those skilled in the art may not be discussed in detail, but where appropriate, the techniques and devices should be considered part of the specification.

In all examples shown and discussed herein, any specific value should be interpreted as merely exemplary rather than a limitation. Therefore, other examples of the exemplary embodiments may have different values.

It should be noted that similar reference numerals and letters represent similar items in the accompanying drawings below. Therefore, once an item is defined in one drawing, it is unnecessary to further discuss the item in the subsequent drawings.

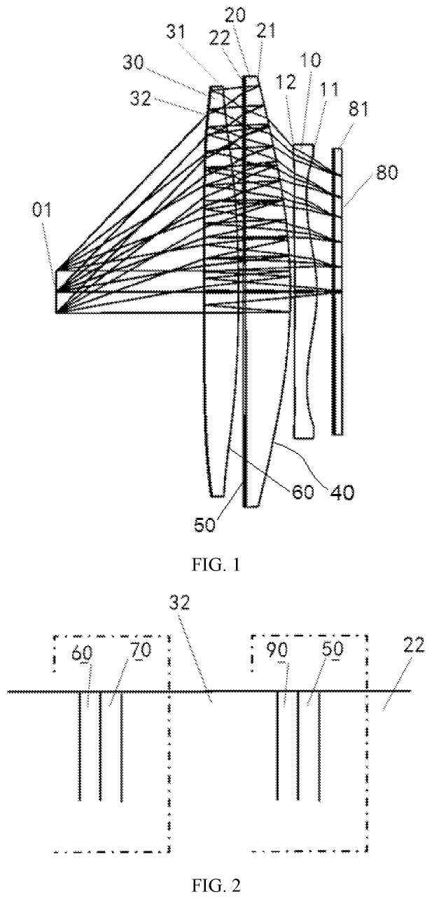

The optical module and the head mounted display device provided by embodiments of the present disclosure are described in detail below in conjunction with FIGS. 1 to 21.

According to an aspect of embodiments of the present disclosure, there is provided an optical module. The optical module is a design of optical structure for a folded optical path, which is suitable for application in a head mounted display (HMD) device. For example, a VR head mounted device, such as may include VR glasses or a VR helmet, etc., which is not specifically limited in the embodiments of the present disclosure.

Embodiments of the present disclosure provide an optical module as shown in FIGS. 1, 2, 9, and 15. The optical module includes: a display 80, a beam splitter 40, a first phase retarder 50, and a polarizing reflection element 60, wherein the first phase retarder 50 is provided between the beam splitter 40 and the polarizing reflection element 60.

The optical module further includes a lens group, and the lens group includes at least a first lens 10 and a second lens 20 arranged sequentially. The first lens 10 is provided between the display 80 and the beam splitter 40, and the second lens 20 is provided on one side of the beam splitter 40 away from the display 80.

As shown in FIG. 8, a ratio of a difference between the optical effective aperture D₂ of the beam splitter 40 and a height D₁ of the effective display area of the display 80 to a distance T between the beam splitter 40 and the display 80 is in a range from 2 to 6.

That is to say, in the embodiment of the present disclosure, the range of (D₂−D₁)/T is controlled to be from 2 to 6.

In the embodiment of the present disclosure, by reasonably constraining the range of (D₂−D₁)/T and arranging the first lens 10 between the beam splitter 40 and the display 80, the angle at which light is incident to the beam splitter 40 and the angle at which the light emitted from the display 80 is incident to the first lens 10 can be significantly improved. This ensures that the angle of incidence of the light from the display 80 into the first lens 10 remains within original angle of incidence of the display 80, thereby enhancing optical efficiency of the optical module.

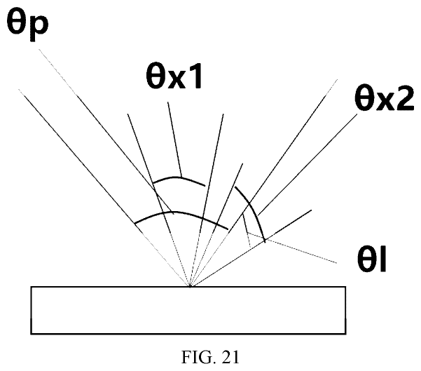

As shown in FIG. 21, Op in FIG. 21 represents an original angle of incidence of the display (or screen), and θx1 in FIG. 21 represents an angle of incidence of light emitted from the display into the first lens 10. θx1 in FIG. 21 illustrates a situation in which the angle of incidence of light emitted from the display into the first lens 10 can be covered by the original angle of incidence of the display, and the light efficiency utilization rate can reach 100%. At this time, the imaging effect of the optical module is excellent.

Please continue to refer to in FIG. 21, when the light emitted from the display is incident to the first lens 10 at a large incident angle, such as θx2 shown in FIG. 21, part of the incident angle, 01, cannot be covered by the original incident angle of the display, which will result in reduction of the light efficiency.

According to an embodiment of the present disclosure, a folded light path solution is provided. By reasonably controlling and constraining the range of (D₂−D₁)/T in the light path structure, and by arranging the first lens 10 between the beam splitter 40 and the display 80, the angle at which light is incident to the beam splitter 40 and the angle at which the light emitted from the display 80 is incident to the first lens 10 can be improved. This ensures that the angle of light emitted from the display 80 into the first lens 10 falls within the range of the original angle of incidence of the display 80, thereby enhancing optical efficiency and improving the imaging quality. This is illustrated by θx1 in FIG. 21, which can improve the light efficiency of the optical module and contribute to improve the imaging quality.

The optical module provided in the embodiments of the present disclosure includes not only the lens group, but also the beam splitter 40, the first phase retarder 50, and the polarizing reflecting element 60 as described above.

Here, the first phase retarder 50 can be used to change the polarization state of the light in the folded optical path structure. For example, it can convert linearly polarized light into circularly polarized light, or convert circularly polarized light into linearly polarized light.

Here, the polarizing reflection element 60 can be used to transmit P-polarized light and reflect the S-polarized light; or, to transmit S-polarized light and reflect the P-polarized light.

The first phase retarder 50 and the polarizing reflection element 60 cooperate to resolve light and deliver the light.

Optionally, the ratio of the difference between the optical effective aperture D₂ of the beam splitter 40 and the height D₁ of the effective display area of the display 80 to the distance T between the beam splitter 40 and the display 80 may also be from 2.8 to 4.5. That is to say, the range of (D₂−D₁)/T can be controlled to be from 2.8 to 4.5.

Optionally, the ratio of the difference between the optical effective aperture D₂ of the beam splitter 40 and the height D₁ of the effective display area of the display 80 to the distance T between the beam splitter 40 and the display 80 is controlled to be from 2.9 to 4.2. That is to say, the range of (D₂−D₁)/T can be controlled to be from 2.9 to 4.2.

Further, the value of (D₂−D₁)/T can, for example, be controlled to be 2.94, 3.5 or 4.2, etc.

Of course, the embodiments of the present disclosure are not limited to the three point values listed in the above examples, and those skilled in the art may flexibly adjust the value of (D₂−D₁)/T within the range of 2 to 6 as needed.

In some examples of the present disclosure, the size of the display 80 is from 1.0 in to 2.1 in. This is a small-sized display.

Embodiments of the present disclosure provide an optical module, which is designed with a folded light path optical structure. As shown in FIGS. 1, 2, 8, 9, and 15, each of optical lenses and optical elements in the optical module can be arranged in a predetermined manner and located on the same optical axis. The overall size of the optical path structure is small and does not occupy a large space. The optical module can cooperate with a small-sized display 80, which contributes to reduce the size of the optical module.

In some examples of the present disclosure, an angle of light incident onto the beam splitter 40 is <65°.

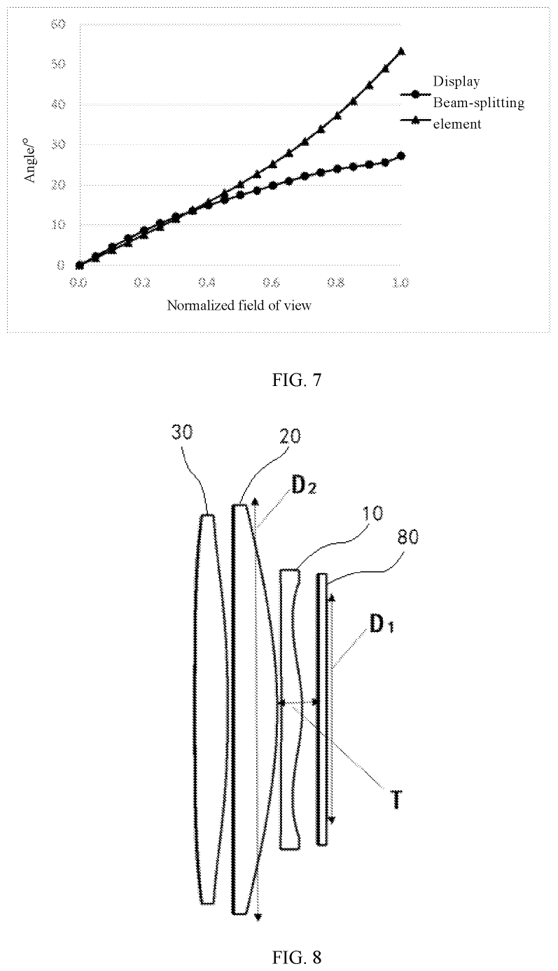

As shown in FIG. 7, FIG. 14, and FIG. 20, in the optical module provided by an embodiment of the present disclosure, the angle of light incident onto the beam splitter 40 can be adjusted to be <65°, and the maximum angle of light incident onto the beam splitter 40 decreases, to effectively improve the reflectivity and transmittance of the beam splitter 40, so that the light efficiency of the optical module can also be enhanced.

Further, the angle of light incident onto the beam splitter 40 is <53°, and may even be ≤40°.

Referring to FIG. 7, FIG. 14, and FIG. 20, in the optical module provided by the embodiments of the present disclosure, after adjustment, the angle of incidence of the light emitted from the display 80 into the first lens 10 may be <35°. The angle of incidence of the light may be covered by the original angle of incidence of the display 80, so that the optical efficiency of the optical module can be improved.

Further, after adjustment, the angle of incidence of the light emitted from the display 80 into the first lens 10 may also be <27°, or may even be <26°. The optical module provided by the embodiments of the present disclosure can enable the user to obtain a better visual experience.

In some examples of the present disclosure, as shown in FIGS. 1, 2, 8, 9, and 15, the optical module further includes a third lens 30. Here the second lens 20 is provided between the first lens 10 and the third lens 30; and either side of the third lens 30 is provided with the first phase retarder 50 and the polarizing reflection element 60.

In embodiments of the present disclosure, three optical lenses are used, i.e. the first lens 10, the second lens 20 and the third lens 30 as described above. Here the first lens 10 is designed to be provided proximate to the incident light, that is, at an appropriate location proximate to the display 80. The incident light may first be emitted into the first lens 10, which is used to transmit the incident light. The third lens 30 is provided proximate to the human eye 01. The second lens 20 is provided at a suitable position between the first lens 10 and the third lens 30.

In the embodiment of the present disclosure, by reasonably arranging the three lenses and effectively constraining the range of (D₂−D₁)/T, the angle at which light is incident to the beam splitter 40 and the angle of incidence of the light emitted from the display 80 into the first lens 10 can be appropriately reduced (e.g., the angle at which light is incident to the beam splitter 40 is less than 65°, and the angle of incidence of light from the display 80 is less than 35°). This ensures that the angle of incidence of light emitted from the display 80 into the display 80 is completely covered by the original emission angle of the display 80, thereby improving the light efficiency of the optical module and enhancing the imaging quality.

In the optical module provided in this embodiment of the present disclosure, in addition to the above-described three optical lenses (3P), it may also include a beam splitter 40 provided between the first lens 10 and the second lens 20, and a first phase retarder 50 (also referred to as a ¼ wave plate) and a polarizing reflective film 60 provided on either of the opposite sides of the third lens 30.

Here, the beam splitter 40 may, for example, be provided at a suitable location between the second lens 20 and the first lens 10. Of course, the beam splitter 40 may also be directly attached to a surface of the second lens 20 facing the first lens 10.

Here, the first phase retarder 50 and the polarizing reflecting element 60 may, for example, be provided at a suitable location between the second lens 20 and the third lens 30. Of course, the first phase retarder 50 and the polarizing reflection element 60 may also be provided at a suitable location on the side of the third lens 30 adjacent to the human eye 01.

Of course, the first phase retarder 50 and the polarizing reflection element 60 can be attached to suitable surfaces of the second lens 20 and/or the third lens 30. Those skilled in the art may flexibly adjust the specific positions of the first phase retarder 50 and the polarizing reflection element 60 as needed.

It should be noted that the first phase retarder 50 and the polarizing reflection element 60 may be attached together, or may be spaced apart, the specific arrangement of which is not limited in the embodiments of the present disclosure.

In some examples of the present disclosure, the first lens 10 has a center thickness T₁: 2 mm<T₁<5 mm. As shown in FIGS. 1, 2, 9, and 15, the first lens 10 includes a first surface 11 and a second surface 12, both of which are aspherical.

Optionally, an anti-reflection film is provided on both sides of the first lens 10.

That is, an anti-reflective film is provided on one side of the first surface 11 and another anti-reflective film is provided on one side of the second surface 12.

For example, an anti-reflective film can be attached to the first surface 11 and the second surface 12, respectively.

In embodiments of the present disclosure, the first lens 10 may be located on the side of the entire optical module proximate to the incident light, or, it can be provided adjacent to the light emergent surface of the display 80. The light emitted from the display 80 can transmit through the first lens 10. An anti-reflection film can be provided on each side of the first lens 10, so that the light can pass through the first lens 10 as completely as possible and be emitted into the optical module.

In some examples of the present disclosure, the first lens 10 has a positive optical power φ₁ which satisfies: 0<φ₁<0.05.

The first lens 10 is not required to provide a large optical power for the optical module.

In the embodiments of the present disclosure, as shown in FIG. 8, the location of the first lens 10 is reasonably arranged in the optical path structure, and (D₂−D₁)/T is constrained within the range of 2 to 6. By considering parameters such as the center thickness, the surface shape, and the optical power of the first lens 10, the angle at which light is incident to the beam splitter 40 and the angle at which the light emitted from the display 80 is incident to the first lens 10 can be reduced.

In some examples of the present disclosure, the aperture D of the third lens 30 satisfies: D₁≤D≤D₂.

As shown in FIG. 8, in the optical module of the embodiment of the present disclosure, the optical effective aperture of the beam splitter 40 is D₂, and the height of the effective display area of the display 80 is D₁.

It should be noted that the height D₁ of the effective display area of the above-described display 80 refers to the larger one of the length and width of the display. When the display 80 is placed normally, D₁ represents the height.

In the optical module of the embodiment of the present disclosure, the aperture of the third lens 30 is designed to be within the above range, so that the light emergent from the display 80 can be refracted by the optical lens with larger aperture before being focused to enter the human eye 01 through the third lens 30 for better display imaging in the human eye 01.

It is to be noted that those skilled in the art may flexibly adjust the value of the aperture of the third lens 30 according to the actual need, as long as it is within the range described above.

In some examples of the present disclosure, as shown in FIGS. 1, 2, 9, and 15, the second lens 20 includes a third surface 21 and a fourth surface 22. The third surface 21 is aspherical, and the fourth surface 22 is planar or aspherical. The third lens 30 includes a fifth surface 31 and a sixth surface 32, and both of the fifth surface 31 and the sixth surface 32 are aspherical; here, the fourth surface 22 and the fifth surface 31 may be provided adjacent to each other.

Optionally, as shown in FIG. 2, an anti-reflection film 90 is provided on one side of the fourth surface 22 of the second lens.

Here the optical power φ₂ of the second lens 20 is positive, and satisfies: 0<2<0.1.

Optionally, an anti-reflective film may also be provided on the fifth surface 31 of the third lens 30, or on one side of the fifth surface 31, which allows the light to enter into the human eye 01 as completely as possible to display the image.

Here, the optical power φ₃ of the third lens 30 is positive, and satisfies: 0<φ₃<0.01.

In embodiments of the present disclosure, the center thickness T₂ of the second lens 20 may be designed to be: 3 mm<T₂<6 mm. The center thickness T₃ of the third lens 30 may be designed to be: 3 mm<T₃<6 mm.

In some examples of the present disclosure, the beam splitter 40 is provided on one side of the third surface 21; the first phase retarder 50 and the polarizing reflection element 60 are arranged sequentially between the fourth surface 22 and the sixth surface 32.

For example, the beam splitter 40 may be provided at a suitable location between the second surface 12 of the first lens 10 and the third surface 21 of the second lens 20. Alternatively, the beam splitter 40 may be provided at a suitable location near the third surface 21 of the second lens 20. Of course, the beam splitter 40 may also be attached on a surface of the third surface 21 of the second lens 20, as shown in FIG. 1.

For example, the first phase retarder 50 may be provided on one side of the fourth surface 22 of the second lens 20, and the polarizing reflection element 60 may be provided on one side of the sixth surface 32 of the third lens 30. At this time, the first phase retarder 50 and the polarizing reflection element 60 are spaced apart in the optical path structure.

For example, the first phase retarder 50 may be provided at a suitable location between the fourth surface 22 of the second lens 20 and the sixth surface 32 of the third lens 30. Alternatively, the first phase retarder 50 is provided at a suitable location adjacent to the fourth surface 22 of the second lens 20.

Of course, the first phase retarder 50 may also be directly attached to the fourth surface 22 of the second lens 20.

For example, the polarizing reflection element 60 may be provided at a suitable location between the fourth surface 22 of the second lens 20 and the sixth surface 32 of the third lens 30. Alternatively, that the polarizing reflection element 60 is provided at a suitable location adjacent to the sixth surface 32 of the third lens 30. Of course, the polarizing reflection element 60 may also be directly attached to the sixth surface 32 of the third lens 30.

In addition, the first phase retarder 50 and the polarization reflecting element 60 may also be designed to be attached in a laminated manner to the sixth surface 32 of the third lens 30. At this time, the first phase retarder 50 and the polarization reflecting element 70 may be attached together. Those skilled in the art may reasonably adjust the positions of the first phase retarder 50 and the polarizing reflection element 60 as needed.

In some examples of the present disclosure, as shown in FIG. 2, the optical module further includes a polarizing film 70, which is provided between the polarizing reflection element 60 and the sixth surface 32.

In some examples of the present disclosure, as shown in FIG. 2, the beam splitter 40 is attached to the third surface 21, the first phase retarder 50 is attached to the fourth surface 22, and the polarizing reflection element 60 and the polarizing film 70 are stacked to form a film layer structure and attached to the sixth surface 32.

In the embodiment of the present disclosure, the second lens 20 includes two optical surfaces, namely the third surface 21 and the fourth surface 22 mentioned above. The third surface 21 and the second surface 12 of the first lens 10 can be adjacently provided, and the beam splitter 40 can be provided on the third surface 21 or on one side adjacent to it. A film layer structure can be provided on the fourth surface 22 or proximate to it, and the film layer structure, for example, includes the first phase retarder 50 and the anti-reflective film 90 as described above. Here the first phase retarder 50 can be used to change a polarization state of light in the folded light path structure.

In an embodiment of the present disclosure, the polarizing reflection element 60 and the polarizing film 70 may be stacked to form a film layer structure, and may be attached to the sixth surface 32. The polarizing reflection element 60 can transmit P-polarized light and reflect S-polarized light, and the polarizing film 70 can transmit P-polarized light, thereby reducing stray light.

In some examples of the present disclosure, the beam splitter 40 has a reflectivity of 47% to 53%.

For example, the beam splitter 40 may be a transflective film.

In some examples of the present disclosure, the first lens 10, the second lens 20, and the third lens 30 have a refractive index n of: 1.4<n<1.7.

The first lens 10, the second lens 20 and the third lens 30 have a dispersion coefficient v of: 20<v<75.

For example, the first lens 10 has a refractive index n₁ of 1.54 and a dispersion coefficient v₁ of 56.3; the second lens 20 has a refractive index n₂ of 1.54 and a dispersion coefficient v₂ of 56.3; and the third lens 30 has a refractive index n₃ of 1.54 and a dispersion coefficient v₃ of 56.3.

In some examples of the present disclosure, as shown in FIGS. 1, 2, 9, and 15, the light emergent surface of the display 80 is configured to be capable of emitting circularly polarized light or linearly polarized light.

When light emitted from the light emergent surface of the display 80 is linearly polarized light, a second phase retarder is provided between the light emergent surface of the display 80 and the first lens 10. The second phase retarder is configured to convert the linearly polarized light into circularly polarized light.

In an embodiment of the present disclosure, the optical module may include a display 80, with a protective glass 81 provided on the light emergent surface of the display 80. The light emergent surface of the display 80 may emit light toward the first lens 10, and the light may pass through the first lens 10.

In embodiments of the present disclosure, the second phase retarder may be provided at the light emergent surface of the display 80, or at a suitable location between the display 80 and the first lens 10, or at a suitable location adjacent to the light emergent surface of the display 80.

According to the optical module provided by embodiments of the present disclosure, the light propagation process is as follows.

As shown in FIG. 1, the display 80 emits circularly polarized light, which is transmitted through the protective glass 81 on the light emergent surface of the display 80. The light is then transmitted through the first lens 10, the second lens 20, and the fifth surface 31 of the third lens 30. It is then reflected by the polarization reflecting element 60 on the sixth surface 32 of the third lens 30. After being transmitted through the fifth surface 31 of the third lens 30 and the fourth surface 22 of the second lens 20, the light is converted from circularly polarized into linearly polarized light by a first phase retarder 50 on the fourth surface 22 or on one side of the fourth surface 22. The light is then reflected by the beam splitter 40 on the third surface 21 of the second lens 20, and again converted to circularly polarized light by the first phase retarder 50 on the fourth surface 22 of the second lens 20 or on one side of the fourth surface 22. Finally, the light is transmitted through the third lens 30 and enters the human eye 01 to display an image.

The optical modules provided by embodiments of the present disclosure are specifically described below by means of three embodiments.

### Embodiment 1

Embodiment 1 of the present disclosure provides an optical module, as shown in FIG. 1. The optical module includes a display 80, a beam splitter 40, a first phase retarder 50 and a polarizing reflection element 60. Here the first phase retarder 50 is provided between the beam splitter 40 and the polarizing reflection element 60.

The optical module further includes: a first lens 10, a second lens 20 and a third lens 30. The first lens 10 is provided between the display 80 and the beam splitter 40, and the second lens 20 is provided between the first lens 10 and the third lens 30. Either side of the third lens 30 is provided with the first phase retarder 50 and the polarizing reflection element 60. As shown in FIG. 8, a ratio of the difference between the optical effective aperture D₂ of the beam splitter 40 and the height D₁ of the effective display area of the display 80 to the distance T between the beam splitter 40 and the display 80 is 4.2. Here the optical effective aperture D₂ of the beam splitter 40 is 42.8 mm, the height D₁ of the effective display area of the display 80 is 22 mm, and the distance T between the beam splitter 40 and the display 80 is 4.95 mm.

Within the above-described range, as shown in FIG. 7, the light emitted from the display 80 enters the first lens 10 at an incident angle which is in a range of <27°, and enters the beam splitter 40 at an incident angle which is in a range of <53°. Here, the aperture D of the third lens 30 satisfies: 22≤D≤42.8.

Here, the first lens 10 includes a first surface 11 and a second surface 12, the second lens 20 includes a third surface 21 and a fourth surface 22, and the third lens 30 includes a fifth surface 31 and a sixth surface 32. In the optical module provided in Embodiment 1, the optical parameters of the first lens 10, the second lens 20, and the third lens 30 may be specified as follows in Table 1.

TABLE 1

| | Radius | Thickness | | | | | |
|---|---|---|---|---|---|---|---|
| Surface | (mm) | (mm) | Material | Conic | A2 | A4 | A6 |
| 32 | 5700.0000 | 3.2478 | APEL | 24.9983 | 0.0000 | 4.669E−06 | 0.000E+00 |
| 31 | −140.1713 | 0.4500 | Air | −24.9998 | 0.0000 | −1.007E−05 | 2.446E−08 |
| 22 | Infinity | 4.2686 | APEL | 0.0000 | 0.0000 | 0.000E+00 | 0.000E+00 |
| 21 | −52.8503 | 0.5000 | Air | −7.6516 | 0.0000 | 9.825E−07 | 0.000E+00 |
| 12 | −130.7641 | 2.0844 | APEL | 15.0000 | 0.0000 | 5.790E−05 | −1.590E−07 |
| 11 | −15.0019 | 1.4835 | Air | −9.7565 | 0.0000 | 1.911E−04 | −1.048E−07 |

| Surface | A8 | A10 | A12 | A14 | A16 |
|---|---|---|---|---|---|
| 32 | 0.000E+00 | 0.000E+00 | 0.000E+00 | 0.000E+00 | 0.000E+00 |
| 31 | −3.783E−12 | 0.000E+00 | 0.000E+00 | 0.000E+00 | 0.000E+00 |
| 22 | 0.000E+00 | 0.000E+00 | 0.000E+00 | 0.000E+00 | 0.000E+00 |
| 21 | 0.000E+00 | 0.000E+00 | 0.000E+00 | 0.000E+00 | 0.000E+00 |
| 12 | −5.908E−10 | −2.037E−12 | 1.998E−14 | 0.000E+00 | 0.000E+00 |
| 11 | 1.339E−09 | 2.304E−11 | −8.275E−14 | 0.000E+00 | 0.000E+00 |

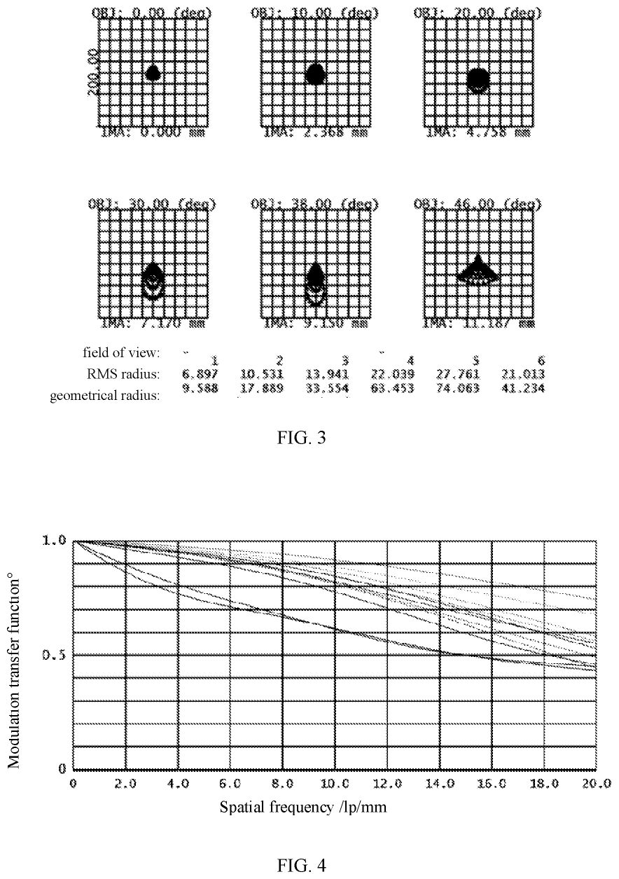

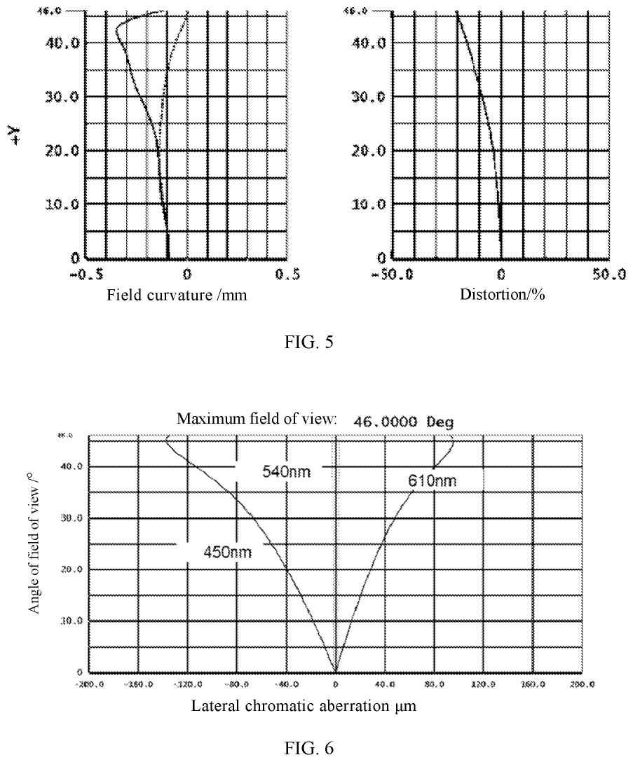

The optical module according to Embodiment 1 is shown in FIGS. 3 to 6. FIG. 3 is a schematic diagram of a spot array diagram of the optical module provided in Embodiment 1, FIG. 4 is a graph of MTF curves of the optical module provided in Embodiment 1, FIG. 5 is a graph of field curvature distortion of the optical module provided in Embodiment 1, and FIG. 6 is a graph of lateral chromatic aberration of the optical module provided in Embodiment 1.

The spot array diagram refers to that after many rays of light emitted from a point passing through the optical module, the intersection points with the image plane are no longer concentrated at the same point due to aberration, and a diffuse pattern scattered in a certain range is formed, which can be used to evaluate the imaging quality of the optical module. As shown in FIG. 3, in Embodiment 1, the maximum value of the image points in the spot array diagram is less than 28 μm.

The graph of the MTF curve is a graph of a modulation transfer function that characterizes the imaging clarity of the optical module by the contrast of the black and white line pairs. As shown in FIG. 4, in Embodiment 1, the MTF is >0.45 at 20 lp/mm, indicating clear imaging.

The graph of field curvature distortion reflects the difference in image plane positions where different fields of view form a clear image. In Embodiment 1, as shown in FIG. 5, the maximum value of the field curvature is less than 0.4 mm, and the maximum distortion in the embodiment occurs at the 1 field of view, with the maximum value of less than 22%.

Lateral chromatic aberration, also known as transverse chromatic aberration, mainly refers to the difference in the focus positions of blue light and red light on the image plane of a main ray of complex color on the object side, which becomes multiple rays when emitted on the image side due to the existence of chromatic dispersion in the refraction system. In Embodiment 1, as shown in FIG. 6, the maximum dispersion is at 1 field of view position of the system, and the maximum chromatic aberration value of the optical module is less than 240 μm.

### Embodiment 2

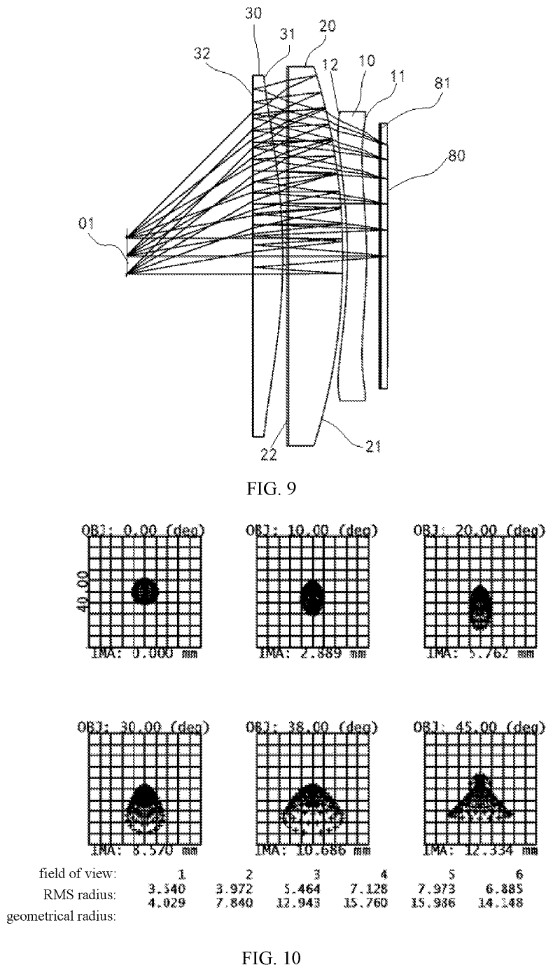

Embodiment 2 of the present disclosure provides an optical module, as shown in FIG. 9. The optical module includes: a display 80, a beam splitter 40, a first phase retarder 50 and a polarizing reflection element 60, wherein the first phase retarder 50 is provided between the beam splitter 40 and the polarizing reflection element 60.

The optical module further includes: a first lens 10, a second lens 20 and a third lens 30. The first lens 10 is provided between the display 80 and the beam splitter 40. The second lens 20 is provided between the first lens 10 and the third lens 30. The first phase retarder 50 and the polarizing reflection element 60 are provided on either side of the third lens 30.

As shown in FIG. 8, a ratio of the difference between the optical effective aperture D₂ of the beam splitter 40 and the height D₁ of the effective display area of the display 80 to the distance T between the beam splitter 40 and the display 80 is 2.94.

Here, the optical effective aperture D₂ of the beam splitter 40 is 40 mm, the height D₁ of the effective display area of the display 80 is 25 mm, and the distance T between the beam splitter 40 and the display 80 is 5.1 mm.

Within the above-described range, as shown in FIG. 14, the light emitted from the display 80 enters the first lens 10 at an incident angle which is in a range of <26°, and enters the beam splitter 40 at an incident angle which is in a range of <41°. Here the aperture D of the third lens 30 satisfies: 25 mm≤D≤40 mm.

Here, the first lens 10 includes a first surface 11 and a second surface 12, the second lens 20 includes a third surface 21 and a fourth surface 22, and the third lens 30 includes a fifth surface 31 and a sixth surface 32. The optical parameters of the first lens 10, the second lens 20 and the third lens 30 may be specified as follows in Table 2.

TABLE 2

| | Radius | Thickness | | | | | |
|---|---|---|---|---|---|---|---|
| Surface | (mm) | (mm) | Material | Conic | A2 | A4 | A6 |
| 32 | Infinity | 3.2478 | APEL | 0.0000 | 0.0000 | 0.000E+00 | 0.000E+00 |
| 31 | −65.5936 | 0.4500 | Air | −24.2514 | 0.0000 | −3.319E−06 | 1.147E−08 |
| 22 | Infinity | 5.9724 | APEL | 0.0000 | 0.0000 | 0.000E+00 | 0.000E+00 |
| 21 | −72.8462 | 0.3800 | Air | 3.3254 | 0.0000 | 1.247E−07 | 1.402E−09 |
| 12 | −75.1516 | 2.1386 | APEL | 5.4066 | 0.0000 | −1.073E−05 | 1.034E−07 |
| 11 | −58.2638 | 1.3900 | Air | 3.2235 | 0.0000 | 4.376E−05 | −2.471E−08 |

| Surface | A8 | A10 | A12 | A14 | A16 |
|---|---|---|---|---|---|
| 32 | 0.000E+00 | 0.000E+00 | 0.000E+00 | 0.000E+00 | 0.000E+00 |
| 31 | −3.783E−12 | 1.159E−14 | 0.000E+00 | 0.000E+00 | 0.000E+00 |
| 22 | 0.000E+00 | 0.000E+00 | 0.000E+00 | 0.000E+00 | 0.000E+00 |
| 21 | 3.269E−11 | 0.000E+00 | 0.000E+00 | 0.000E+00 | 0.000E+00 |
| 12 | 0.000E+00 | 0.000E+00 | 0.000E+00 | 0.000E+00 | 0.000E+00 |
| 11 | 0.000E+00 | 0.000E+00 | 0.000E+00 | 0.000E+00 | 0.000E+00 |

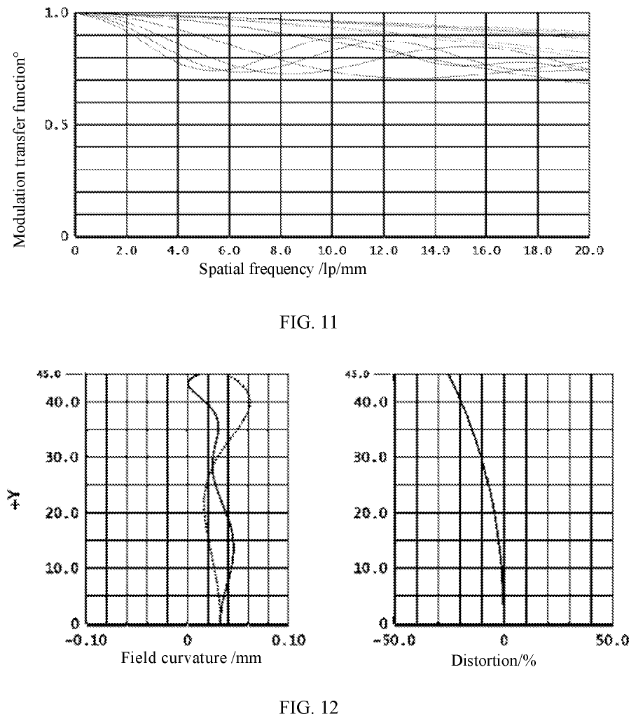

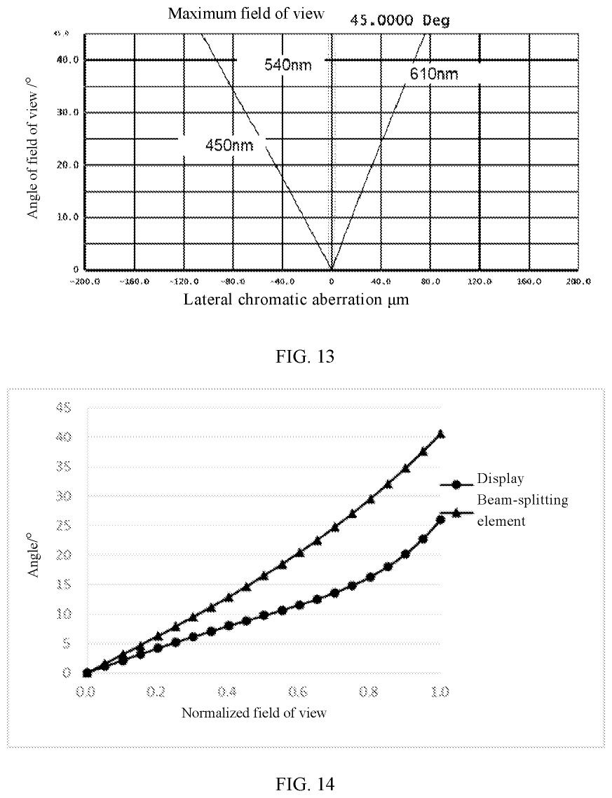

The optical module according to Embodiment 2 is shown in FIGS. 10 to 13. FIG. 10 is a schematic diagram of a spot array diagram of the optical module provided in Embodiment 2, FIG. 11 is a graph of MTF curves of the optical module provided in Embodiment 2, FIG. 12 is a graph of field curvature distortion of the optical module provided in Embodiment 2, and FIG. 13 is a graph of lateral chromatic aberration of the optical module provided in Embodiment 2.

As shown in FIG. 10, in Embodiment 2, the maximum value of the image points in the spot array diagram is less than 8 μm.

As shown in FIG. 11, in Embodiment 2, the MTF is >0.65 at 20 lp/mm, indicating clear imaging.

As shown in FIG. 12, the field curvature distortion value is less than 0.06 mm, and the maximum distortion in the embodiment occurs at 1 field of view, with the maximum value of less than 25%.

As shown in FIG. 13, in Embodiment 2, the maximum dispersion is at 1 field of view position of the system, and the maximum chromatic aberration value of the optical module is less than 190 μm.

### Embodiment 3

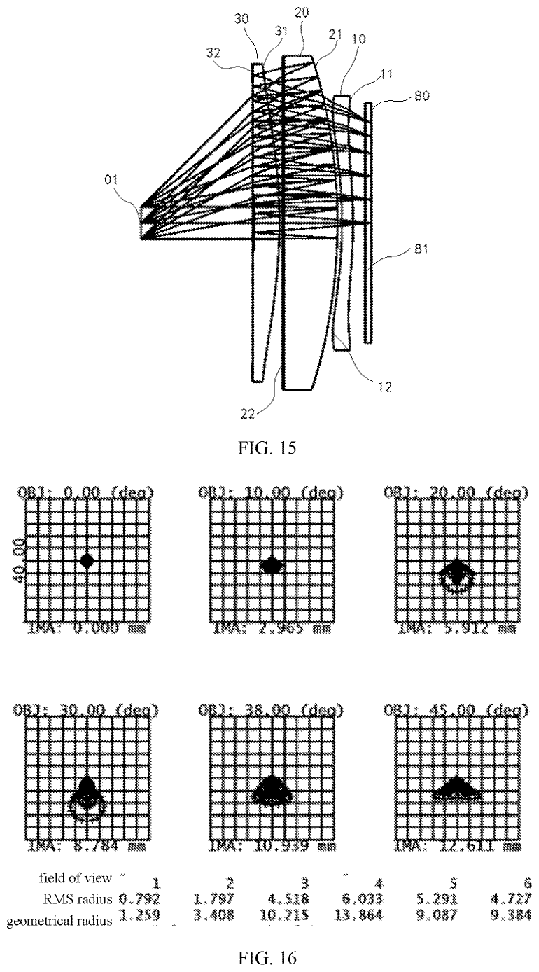

Embodiment 3 of the present disclosure provides an optical module, as shown in FIG. 15. The optical module includes: a display 80, a beam splitter 40, a first phase retarder 50 and a polarizing reflection element 60, wherein the first phase retarder 50 is provided between the beam splitter 40 and the polarizing reflection element 60.

The optical module further includes: a first lens 10, a second lens 20 and a third lens 30. The first lens 10 is provided between the display 80 and the beam splitter 40. The second lens 20 is provided between the first lens 10 and the third lens 30. The first phase retarder 50 and the polarizing reflection element 60 are provided on either side of the third lens 30.

As shown in FIG. 8, a ratio of the difference between the optical effective aperture D₂ of the beam splitter 40 and the height D₁ of the effective display area of the display 80 to the distance T between the beam splitter 40 and the display 80 is 3.5.

Here the optical effective aperture D₂ of the beam splitter 40 is 40 mm, the height D₁ of the effective display area of the display 80 is 25 mm, and the distance T between the beam splitter 40 and the display 80 is 4.3 mm.

Within the above-described range, as shown in FIG. 20, the light emitted from the display 80 enters the first lens 10 at an incident angle which is in a range of <26°, and enters the beam splitter 40 at an incident angle which is in a range of <40°. Here the aperture D of the third lens 30 satisfies: 25 mm≤D≤40 mm.

Here, the first lens 10 includes a first surface 11 and a second surface 12, the second lens 20 includes a third surface 21 and a fourth surface 22, and the third lens 30 includes a fifth surface 31 and a sixth surface 32. The optical parameters of the first lens 10, the second lens 20 and the third lens 30 in the optical module provided in Embodiment 3 may be specified as follows in Table 3.

TABLE 3

| | Radius | Thickness | | | | | |
|---|---|---|---|---|---|---|---|
| Surface | (mm) | (mm) | Material | Conic | A2 | A4 | A6 |
| 32 | −2751.0774 | 3.2478 | K26R | 0.0000 | 0.0000 | 0.000E+00 | 0.000E+00 |
| 31 | −66.3941 | 0.3397 | Air | 0.0000 | 0.0000 | −2.910E−06 | 1.134E−08 |
| 22 | Infinity | 6.7445 | APEL | 0.0000 | 0.0000 | 0.000E+00 | 0.000E+00 |
| 21 | −72.9569 | 0.5529 | Air | 3.0925 | 0.0000 | 1.066E−07 | 7.809E−10 |
| 12 | −70.0602 | 1.4302 | APEL | 8.2630 | 0.0000 | −1.088E−05 | 1.100E−07 |
| 11 | −59.9618 | 1.4000 | Air | 5.1972 | 0.0000 | 3.586E−05 | −2.185E−08 |

| Surface | A8 | A10 | A12 | A14 | A16 |
|---|---|---|---|---|---|
| 32 | 0.000E+00 | 0.000E+00 | 0.000E+00 | 0.000E+00 | 0.000E+00 |
| 31 | −6.818E−12 | 0.000E+00 | 0.000E+00 | 0.000E+00 | 0.000E+00 |
| 22 | 0.000E+00 | 0.000E+00 | 0.000E+00 | 0.000E+00 | 0.000E+00 |
| 21 | 0.000E+00 | 0.000E+00 | 0.000E+00 | 0.000E+00 | 0.000E+00 |
| 12 | 1.256E−11 | 0.000E+00 | 0.000E+00 | 0.000E+00 | 0.000E+00 |
| 11 | 6.572E−11 | 0.000E+00 | 0.000E+00 | 0.000E+00 | 0.000E+00 |

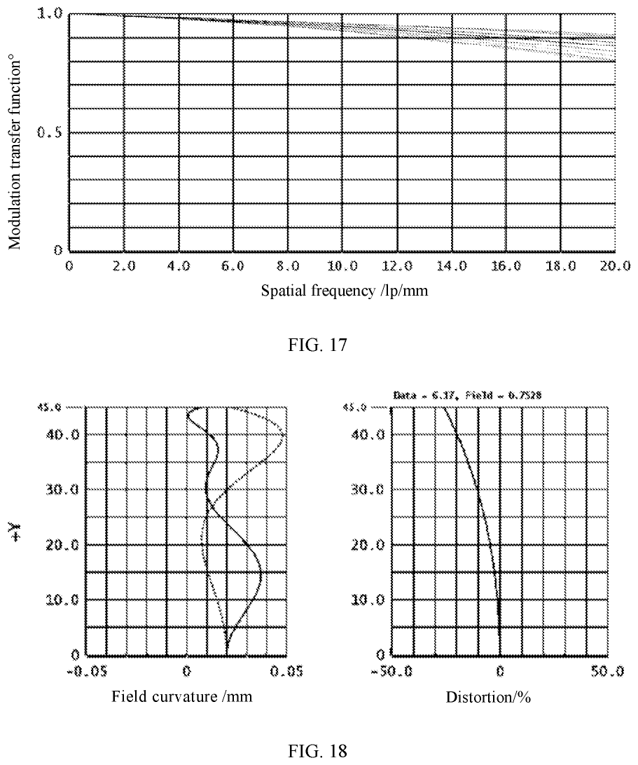

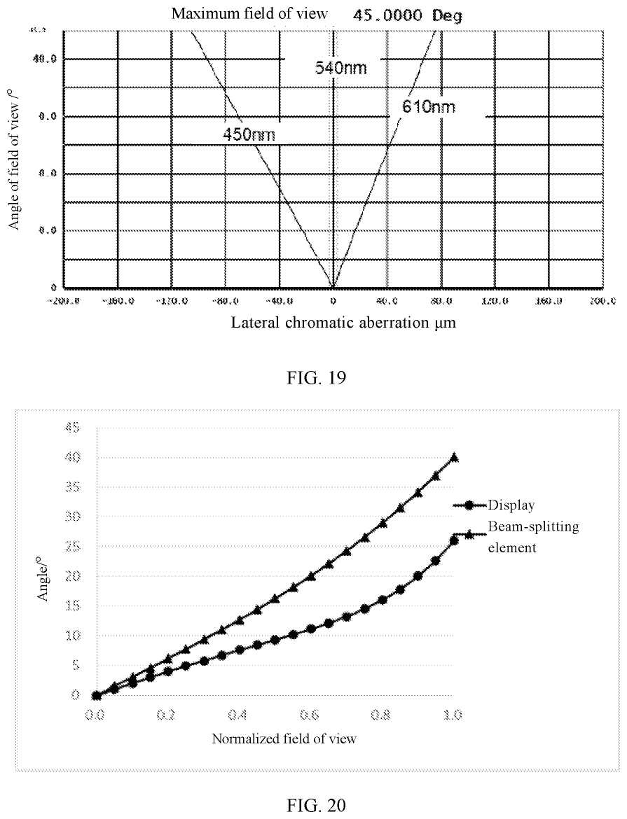

The optical module according to Embodiment 3 is shown in FIGS. 16 to 19. FIG. 16 is a schematic diagram of a spot array diagram of the optical module provided in Embodiment 3, FIG. 17 is a graph of MTF curves of the optical module provided in Embodiment 3, FIG. 18 is a graph of a field curvature distortion of the optical module provided in Embodiment 3, and FIG. 19 is a graph of a lateral chromatic aberration of the optical module provided in Embodiment 3.

As shown in FIG. 16, in Embodiment 3, the maximum value of the image points in the spot array diagram is less than 7 μm.

As shown in FIG. 17, in Embodiment 3, the MTF is >0.75 at 20 lp/mm, indicating clear imaging.

As shown in FIG. 18, the maximum value of field curvature is less than 0.05 mm, and the maximum distortion in the embodiment occurs at 1 field of view with the maximum value of less than 25%.

As shown in FIG. 19, in Embodiment 3, the maximum dispersion is at 1 field of view position of the system and the maximum chromatic aberration value of the optical module is less than 190 μm.

According to another aspect of embodiments of the present disclosure, a head mounted display device is also provided. The head mounted display device includes a housing, and the optical module as described above.

The head mounted display device is, for example, a VR head mounted device, including VR glasses or a VR helmet, etc., which is not specifically limited in the embodiments of the present disclosure.

Specific implementations of the head mounted display device of the embodiments of the present disclosure can be referred to the embodiments of the above mentioned display module and will not be repeated herein.

The above embodiments focus on describing the differences between the various embodiments, and the optimization features between the various embodiments, as long as they do not contradict each other, can be combined to form a more optimal embodiment, which will not be repeated herein considering the brevity of the text.

Although some particular embodiments of the present disclosure have been described in detail by way of example, those skilled in the art should understand that the above examples are for illustrative purposes only and are not intended to limit the scope of the present disclosure. Those skilled in the art should understand that the above embodiments may be modified without departing from the scope and spirit of the present disclosure. The scope of the disclosure is limited by the appended claims.

1. An optical module, characterized by comprising a display (80), a beam splitter (40), a first phase retarder (50) and a polarizing reflection element (60),
wherein the first phase retarder (50) is provided between the beam splitter (40) and the polarizing reflection element (60);
wherein the optical module further comprises a first lens (10) and a second lens (20) arranged sequentially, the first lens (10) is provided between the display (80) and the beam splitter (40), and the second lens (20) is provided on one side of the beam splitter (40) away from the display (80); and
wherein a ratio of a difference between an optical effective aperture D₂ of the beam splitter (40) and a height D₁ of an effective display area of the display (80) to a distance T between the beam splitter (40) and the display (80) is in a range from 2 to 6.

2. The optical module according to claim 1, wherein the ratio of the difference between the optical effective aperture D₂ of the beam splitter (40) and the height D₁ of the effective display area of the display (80) to the distance T between the beam splitter (40) and the display (80) is in a range from 2.9 to 4.2.

3. The optical module according to claim 1, wherein the display (80) has a size of 1.0 inches to 2.1 inches.

4. The optical module according to claim 1, wherein an angle of light incident onto the beam splitter (40) is smaller than 65°.

5. The optical module according to claim 1, wherein the optical module further comprises a third lens (30), and the second lens (20) is provided between the first lens (10) and the third lens (30);
wherein either side of the third lens (30) is provided with the first phase retarder (50) and the polarizing reflection element (60).

6. The optical module according to claim 1, wherein a center thickness T₁ of the first lens (10) is 2 mm<T₁<5 mm;
wherein the first lens (10) comprises a first surface (11) and a second surface (12), both of which are aspherical.

7. The optical module according to claim 1, wherein the first lens (10) has an optical power φ₁, which is positive and satisfies: 0<φ₁<0.05.

8. The optical module according to claim 5, wherein an aperture D of the third lens (30) satisfies: D₁≤D≤D₂.

9. The optical module according to claim 5, wherein the second lens (20) comprises a third surface (21) and a fourth surface (22), the third surface (21) is aspherical, and the fourth surface (22) is planar or aspherical;
wherein the third lens (30) comprises a fifth surface (31) and a sixth surface (32), both of which are aspherical; and
wherein the fourth surface (22) is provided adjacent to the fifth surface (31).

10. The optical module according to claim 9, wherein the beam splitter (40) is provided on one side of the third surface (21); and
wherein the first phase retarder (50) and the polarizing reflection element (60) are arranged sequentially between the fourth surface (22) and the sixth surface (32).

11. The optical module according to claim 10, wherein the optical module further comprises a polarizing film (70) provided between the polarizing reflection element (60) and the sixth surface (32).

12. The optical module according to claim 11, wherein the beam splitter (40) is attached to the third surface (21);
wherein the first phase retarder (50) is attached to the fourth surface (22);
wherein the polarizing reflection element (60) and the polarizing film (70) are stacked to form a film layer structure and attached to the sixth surface (32).

13. The optical module according to claim 5, wherein the first lens (10), the second lens (20) and the third lens (30) have a refractive index n of: 1.4<n<1.7; and
wherein a dispersion coefficient v of the first lens (10), the second lens (20) and the third lens (30) is: 20<v<75.

14. The optical module according to claim 1, wherein the beam splitter (40) has a reflectivity of 47% to 53%.

15. The optical module according to claim 1, wherein a light emergent surface of the display (80) is configured to emit circularly polarized light or linearly polarized light; and
when light emitted from the light emergent surface of the display (80) is linearly polarized light, a second phase retarder is provided between the light emergent surface of the display (80) and the first lens (10), and the second phase retarder is configured to convert the linearly polarized light into circularly polarized light.

16. A head mounted display device, characterized by comprising:
a housing; and
the optical module according to any one of claims 1 to 15.
